(19) United States
(12) Patent Application Publication
(10) Pub. No.: US 2019/0107295 A1
(43) Pub. Date: Apr. 11, 2019

(54) Device and Method For Configuring a Multivalent Energy Supply Installation

(71) Applicant: Viessmann Werke GmbH & Co. KG, Allendorf (DE)

(72) Inventors: Christian ARNOLD, Neuhof-Rommerz (DE); Martin BOCK, Frankenau (DE); Andrej GRAD, Bromskirchen (DE); Tobias MAURER, Allendorf (DE); Reinhard OSTERLOH, Winterberg (DE); Jörg TIMMERMANN, Battenberg (DE)

(21) Appl. No.: 16/087,660

(22) PCT Filed: Mar. 23, 2017
(86) PCT No.: PCT/EP2017/056930

§ 371 Date: Sep. 23, 2018

(30) Foreign Application Priority Data
Mar. 24, 2016 (DE) 10 2016 205 033.8

(51) Int. Cl. F24D 19/10; F24D 12/02; F24D 11/00; F24H 9/14; F24D 17/00; G05B 19/042

(52) U.S. Cl. CPC F24D 19/1081; F24D 12/02; F24D 11/002; F24H 9/148; H02J 3/381; G05B 19/042; F24D 2200/32; F24D 2200/04; F24D 2200/08; F24D 17/0036

(57) ABSTRACT

The present invention relates to an apparatus for configuring a multivalent energy supply system. The apparatus comprises a memory device in which a base configuration is stored. The base configuration includes a plurality of energy generators which use at least two different energy carriers to provide energy in the form of heat and/or cold and/or electrical energy, a flow through which a carrier medium flows which receives energy from the energy generators and transports it to a consumer circuit, and a return flow which receives the carrier medium coming from the consumer circuit. The base configuration further comprises a buffer storage which is arranged between the flow and the return flow. The energy generators within the base configuration may be arranged at positions in parallel to the buffer storage between the flow and the return flow and/or in series in the flow. The apparatus further comprises a detection device configured to detect, for each of the energy generators, a type from a predetermined set of energy generator types and a position of the energy generator within the base configuration stored in the memory device. The apparatus is configured to transmit the base configuration to a control device which controls the energy generators based on their detected type and position within the base configuration.

The present invention relates to an apparatus and a method for configuring a multivalent energy supply system.

A method of operating a system comprising a plurality of heat generating means is known, for example, from EP 2187136 A2. The system may provide heat power using a plurality of heat generating means, wherein the allocation of the heat power to the individual heat generating means is variable so that they can be operated close to their optimal efficiency. The allocation of power may not only be performed by means of a higher-level boiler management system, but may also be carried out by coordinating the individual heat generating means with each other.

From the International Patent Application WO 2009/141176 A1, a mobile heating system is known which comprises a plurality of fuel-operated heating devices which are in communication with each other via a bus system. The heating system is configured such that, when starting the heating system, one of the heating devices is configured based on predetermined rules as a master with respect to the control of other heating devices connected to the bus system. The remaining heating devices are configured as slaves.

A hybrid heating system comprising at least one condensing boiler and at least one non-condensing boiler is known from the International Patent Application WO 2008/091970 A2. Switching on or off the individual boilers is carried out by a control after determining the heat load, inter alia, based on the flow in the main line of the heating system as well as other starting criteria. The selection of the boilers is carried out based on the ambient temperature and the operating hours of the individual boilers.

The object of the present invention is to provide an apparatus for configuring a multivalent energy supply system. In particular, such an apparatus is to be improved in such a way that a variety of different system configurations can be generated.

The object is achieved by providing an apparatus for configuring a multivalent energy generation system, the apparatus comprising a memory device in which a base configuration is stored. The base configuration is a schematic representation of a generalized infrastructure of a multivalent energy supply system. The base configuration includes placeholders for possible components of the energy supply system and their relationships with each other. In particular, the base configuration includes a plurality of energy generators which use at least two different energy carriers to provide energy in the form of heat and/or cold and/or electrical energy.

The base configuration may be adapted to an actual or planned system configuration by replacing the placeholders with the components actually present in the multivalent energy supply system. The result of the adaptation may be, for example, a system configuration in the form of a hydraulic scheme of a heating system and/or a block diagram of a multivalent energy supply system which graphically illustrates the relationships between the individual components and/r their functions and/or their effects. The hydraulic scheme and/or the block diagram may be used to configure a control device for controlling the multivalent energy supply system. The memory device may be configured to store the hydraulic scheme or the block diagram. Furthermore, the apparatus may be configured to transmit the hydraulic scheme or the block diagram to a control device for controlling the multivalent energy supply system, for example via a suitable data communication link.

The apparatus for configuring a multivalent energy supply system may be implemented as an electronic data processing device, such as a computer, a tablet computer, a smartphone, a laptop or another electronic control device, in particular comprising a microprocessor. The apparatus for configuring may be configured to communicate with the control device for controlling the multivalent energy supply system. The apparatus may also be implemented as part of the control device for controlling the multivalent energy supply system. The apparatus for configuring is designed to transmit the base configuration or a specific system configuration generated from the base configuration to the control device, so that the control device can control the energy generators depending on their detected type and position within the base configuration or the generated system configuration.

The control device which is adapted to be configured based on a base configuration according to the invention, may control a plurality of multivalent energy supply systems and maybe adapted to changing system configurations by simply adding or removing individual components.

The object may also be achieved by specifying a method for configuring a multivalent energy supply system. The method comprises a first step of reading a base configuration from a memory device. By means of a detection device, a type from a predetermined set of energy generator types and a position of the energy generator within the base configuration are detected for each of the energy generators. From the base configuration and the detected types and positions of energy generators, a specific system configuration is generated. The generated system configuration is transmitted to a control device, so that the control device controls the energy generators in dependence of the transmitted system configuration.

The base configuration comprises a flow through which a carrier medium flows which receives energy from the energy generators and transports it to a consumer circuit. The consumer circuit may include a variety of different and/or similar consumers. A consumer may be any device that consumes energy, such as a radiator.

In the case of a heating system, the flow may be implemented as a pipe in which a fluid carrier medium flows which absorbs heat from an energy generator embodied as a heating boiler. In the case of an electric energy generator, the flow is an electrical line in which electrical energy flows in the form of electrical current. Correspondingly, the charge carriers in the electrical line can then be understood as carrier medium.

The base configuration also includes a return flow which returns the carrier medium coming from the consumer circuit to the energy generator. As with the flow, in the case of a heating system, the return flow may be a pipe in which the fluid carrier medium flows from the consumer circuit back to the generator circuit. Accordingly, in the case of an electric energy generator, the return flow is an electrical line which closes the electrical circuit from the consumer to the energy generator. Since this can also be achieved via the ground potential, no direct conductor connection as return flow between consumers and energy generators is necessary in such cases.

The base configuration further comprises a buffer storage for temporarily storing energy in the form of heat and/or cold and/or electrical energy (for example, in the form of electrical charge). A buffer storage may be, for example, a hot water tank, a battery, a rechargeable battery or a capacitor. The buffer storage is connected to the flow in order to be able to receive energy. Further, the buffer storage may be connected to the return flow. The energy supply takes place via the flow. The retrieval of the energy from the buffer storage may also take place via the flow. For this purpose, the buffer storage may include valves or switches, via which a supply and retrieval of the energy can be controlled accordingly.

A first energy transfer may be arranged in the base configuration. With respect to the buffer storage, the energy transfer is preferably arranged downstream at the flow. Here, the term downstream refers to the flow direction of a carrier medium from the energy generators to the consumer circuit. At the energy transfer, an exchange of energy between the generator circuit (primary side) and a consumer circuit (secondary side) may take place. The energy transfer may also be arranged at the return flow.

An energy transfer may be a heat transfer at which heat is transferred from the carrier medium of the generator circuit (primary side) to a carrier medium of the consumer circuit (secondary side). The two circuits are usually separated, so that the carrier media cannot mix. The heat transfer takes place via materials which are particularly good heat conductors.

By using an energy transfer, a direct exchange of carrier media between the generator circuit and a consumer circuit may be avoided. Thus, only energy transfer but no material transfer from the generator side (primary side) carrier medium to a consumer side (secondary side) carrier medium takes place.

Within the base configuration, the energy generators are arranged at different positions in parallel to the buffer storage between flow and return flow. They may be arranged on both sides of the buffer storage, i.e., downstream and/or upstream, at the flow. In addition, energy generators may be arranged in series in the flow. In particular, the energy generator may be arranged between a buffer storage and a first energy transfer in the flow. For example, an energy generator connected in series may increase the energy content of a carrier medium coming from the buffer storage without adding an amount of the carrier medium from the return flow.

From a base configuration, an actual hydraulic scheme or an actual infrastructure of a multivalent energy supply system may be determined by selecting the components. The individual selectable components also include information on their functions and effects. The base configuration and a hydraulic scheme or block diagram also graphically depict the relationships, such as the hydraulic connection, between the individual components.

The control of multivalent energy supply systems may be very complex and usually requires customized, tailored solutions. The development effort and the associated costs for providing a system control may be very high depending on the complexity of the energy supply system. On the other hand, when installing an energy supply system, the configuration of a corresponding control may be very complicated and time-consuming. The aim of the invention is therefore to provide an apparatus which makes it possible to configure a plurality of different multivalent energy supply systems based on a base configuration. The base configuration may represent relationships, functions and effects of a plurality of components. A control device may be configured based on a base configuration to control a multivalent energy supply system.

A multivalent energy supply system is an energy supply system that uses more than one energy carrier as an energy source. It comprises at least two energy generators, each providing a usable form of energy, such as heat, cold, mechanical energy and/or electrical energy (for example, electric current and/or electric voltage). Heat can be provided, for example, to a hot water supply and/or a heating system and/or as process heat, for example for industrial applications. For transporting the heat, a fluid carrier medium, i.e., a gas or a liquid, is usually used, for example water or steam.

In order to optimally operate a multivalent energy supply system, the control of the energy supply system must be carried out depending on the specific characteristics of the energy generators which depend, inter alia, on the type of energy carrier used. The present invention aims at combining these specific characteristics in a synergistic manner. In other words, the method according to the invention makes it possible to optimally combine the respective advantages of different energy carriers. This is achieved by a coordinated control of the energy generators, so that an additional benefit may be obtained from the multivalence of the energy supply system. In particular, a combination of regenerative and fossil energy carriers may be used, so that both a particularly efficient and economical operation of the energy supply system with reliable energy provision is achieved. The energy supply system control also aims at the ability to react to changing conditions. For example, a strong fluctuation in the availability of one of the energy carriers used may be compensated by using at least one second energy carrier available at all times.

The at least two energy generators of the multivalent energy supply system use at least two different energy sources. As energy carriers, for example, fossil and/or regenerative energy carriers may be used. For example, two or more of the following may be used: coal, natural gas, heating oil, diesel, gasoline, hydrogen, biogas, wood (for example in the form of pellets) or other types of biomass, geothermal energy, solar radiation, wind, electrical energy (for example, electric current and/or electric voltage), long-distance heating, mechanical energy (for example, hydropower).

A multivalent energy supply system according to the invention comprises at least two energy generators, for example two or more from the following list: oil-fired boiler, gas-fired boiler, condensing boiler, combined heat and power plant (CHP), wood-fired boiler, electric heat pump, photovoltaic system, wind turbine, solar thermal collector, fuel cell. In addition, a combined heat and energy generation may, for example, be implemented with a Stirling engine.

The various energy generators may have very different characteristics and may accordingly have different or even conflicting requirements during their operation in a multivalent energy supply system. In the following, typical characteristics of selected energy generators are described by way of example.

An oil-fired boiler or gas-fired boiler uses the fossil energy sources heating oil or natural gas and provides heat which is usually transferred to a fluid carrier medium, typically water. It can supply large power outputs within a short time and can be switched off quickly. Such a boiler is easy to control and may therefore be used in modulating operation. A boiler also allows frequent switch-on/off operations and may therefore also be used in two stages in on/off operation. Oil-fired boilers and gas-fired boilers are thus particularly flexible in their operation and are often used as so-called peak-load boilers which are to respond quickly to fluctuations in energy supply requests.

A combined heat and power plant (CHP) usually uses fossil energy carriers, but could also operate on biogas or hydrogen derived from renewable sources. It supplies heat and electrical energy (electric current and/or electric voltage), is easy to control and can quickly be ramped up to high power output and quickly shut down again. Unlike the boiler, however, the CHP should not be switched on or off frequently. In order to operate a CHP economically, it is usually used in continuous operation.

A wood-fired boiler uses solid fuel from a renewable energy source (wood, for example in the form of pellets or wood chips) and provides heat. It is only moderately controllable and can only relatively slowly be ramped up to high power output or shut down again. Due to the long switching times, a wood boiler should not be switched on or off frequently. When switching off, for safety reasons it is usually necessary to wait until the fuel already in the combustion chamber is completely burnt. When switching on, however, first sufficient fuel must be transported into the combustion chamber and ignited. It causes relatively low overall energy costs. Therefore, it is usually used as a base load boiler which is kept in continuous operation if possible and can meet a minimum energy request of an energy supply system.

In order to be able to react to fluctuations in the demanded amount of energy, a wood boiler is usually used in combination with a buffer storage which intermediately stores the heat provided by the wood boiler when the amount of heat demanded by the consumers is less than the amount of heat provided by the wood boiler. If the amount of heat demanded by the consumers is greater than the amount of heat provided by the wood boiler, first the amount of heat stored may be released from the buffer storage again. Alternatively or in addition to the buffer storage, a gas boiler is often used together with wood boilers in an energy supply system. The gas boiler is then turned on when the demanded amount of heat exceeds the amount of heat available from the wood boiler and from the buffer storage. The gas boiler is therefore used as a peak load boiler.

An electric heat pump consumes electrical energy and therefore uses fossil and/or regenerative energy sources depending on which source the electrical energy was derived from. It can provide heat and/or cold, but has a limited temperature range. Usually, a heat pump can provide a maximum flow temperature of 60° C. It is easy to control and can quickly be ramped up to high power output and can also be quickly shut down again. However, it may not be switched on or off frequently. It causes relatively low overall energy costs.

Another component that is used in many multivalent energy supply systems is a buffer storage. The buffer storage may intermediately store energy provided by energy generators. Depending on the energy form, a buffer storage may be, for example, a storage for electrical energy, for example in the form of batteries or capacitors, or a heat storage and/or cold storage, for example in the form of an insulated water tank. In addition, energy may also be stored in the form of mechanical energy, for example in a flywheel. A buffer storage allows at least partial decoupling of the operation of the energy generators from the energy consumers. As a result, the efficiency of a multivalent energy supply system may be improved.

In a multivalent energy supply system, there may also be energy generators which can simultaneously provide more than one energy form. Depending on the requirements, it may be necessary to determine the conditions under which such energy generators should be switched and/or controlled. With the aid of a hydraulic scheme or block diagram, a control device may determine which energy generators can or should be switched on according to which criteria. In addition, the hydraulic scheme or the block diagram may indicate which types of energy generator are represented in the energy supply system. In addition, the control device receives information on the respective characteristics of the energy generators which have already been exemplified in detail for some energy generators.

Furthermore, a hydraulic scheme or block diagram may contain information on controllable means of a component. For example, the energy generators may include one or more of the following means: temperature sensors, current sensors (volume flow and/or electric current), circulation pump, generator pump, valves, return flow mixer, flow mixer, bypass, throttle.

Further, in the flow and/or return flow, valves, temperature sensors, current/flow measuring devices (for measuring an electrical current or for measuring a volume flow), voltage measuring devices (for measuring an electrical voltage), diodes, fuses, and/or other components which can be controlled by the control device or provide the control device with information on operating states may be arranged. The hydraulic scheme or block diagram obtained from the base configuration also includes the position of the respective components, so that the control device may determine target values for the energy generators, for example, for a required system flow temperature at a specific point in the energy supply system, in order to meet the request.

A CHP can provide both heat and electrical energy (electric current and/or electric voltage). Consequently, two different requests from the two energy forms may be present for a CHP. In the absence of a corresponding request from the consumers supplied by the multivalent energy supply system, the electrical energy provided by the CHP may be fed into a public power grid at all times. The system configuration also includes information on an energy transfer to a public power grid.

Each energy generator in the energy supply system includes a closed-loop controller for controlling state variables of the energy generator. State variables of an energy generator include, for example, a boiler temperature of the energy generator, a volume and/or mass flow of a carrier medium through the energy generator, a temperature of the carrier medium at the flow and/or the return flow of the energy generator, a power consumption of the energy generator and/or a power output of the energy generator. For an energy generator that provides electrical energy, the state variables may relate to an electrical current, an electrical power and/or an electrical voltage.

The closed-loop controllers are coordinated by a control device which is superordinate to the closed-loop controllers. The control device is configured to detect an energy supply request for energy in the form of heat and/or cold and/or electrical energy. An energy supply request may be, for example, a request for a certain flow temperature at a predetermined location of the hydraulic scheme or a specific temperature in a buffer storage, in particular in a certain portion of the buffer storage, or an electrical power at an energy transfer. For example, the energy supply request may be generated by a consumer or a group of consumers and may be output to the control device via an appropriate data communication link. Using the configured hydraulic scheme or the block diagram, the control device determines which energy generator at which position or which buffer storage can be used to meet the energy supply request.

Advantageous embodiments and developments which can be used individually or in combination with each other, are the subject of the dependent claims.

A preferred base configuration comprises at least two energy generators arranged in parallel between a flow and a return flow.

At least two energy generators may be arranged upstream with respect to the buffer storage at the flow. Here, upstream means counter to the flow direction, in particular with respect to a pipe in which a liquid carrier medium flows. Accordingly, downstream means along the flow direction of the support medium. In principle, the number of energy generators may be arbitrarily high.

In a preferred base configuration, at least one energy generator is arranged downstream at the flow with respect to the buffer storage. The energy supplied by the energy generator might not be stored in the buffer storage but always flows directly to the consumers via the flow. Such an energy generator downstream of the buffer storage may be used, for example, in a heating system in order to increase the flow temperature of the carrier medium coming from the buffer storage to a higher temperature, if needed.

In the base configuration, at least one primary-side energy transfer upstream of the first energy transfer at the flow and/or at least one secondary-side energy transfer downstream of the first energy transfer at the flow may be arranged in parallel to the first energy transfer. Via the primary-side and secondary-side energy transfer, further consumer circuits independent of each other may be supplied with energy.

In the base configuration, at least one primary-side buffer storage upstream of the first buffer storage at the flow and/or at least one secondary-side buffer storage downstream of the first buffer storage at the flow may be arranged in parallel to the first buffer storage. If the first buffer storage already

At least one energy generator may be arranged in series between the buffer storage and the energy transfer in the flow. An energy generator connected in series may, for example, be a gas boiler capable of directly raising a flow temperature without adding an amount of the carrier medium from the return flow. Such a heating boiler connected in series may thus function as a flow-type heater.

The detection device may be configured to detect, for each of the buffer storages, one of a predetermined set of buffer storage types. This includes, among other things which type of energy is stored. Furthermore, a specific embodiment of such a buffer may be selected, for example from a list. For this purpose, functional details of the buffer storage may also be stored. A possible selectable type of buffer may also be a simple direct connection which is selected when there is no buffer storage present at the respective position (first buffer storage, primary-side, secondary-side). It is also possible to select or detect buffer storages with or without an admixing pump, with or without a return flow mixer, with or without a buffer discharge valve, with or without a buffer discharge pump and/or with or without temperature sensors.

The detection device may further be configured to detect one of a predetermined set of energy transfer modes for each of the energy transfers.

Here, it is detected which type of energy is transferred. Furthermore, a specific embodiment of such a component may be selected, for example, from a list. For this purpose, functional details of the component may also be stored. A possible selectable energy transfer mode may also be a simple direct connection which may be selected when there is no energy transfer at the respective position. It is also possible to select or detect energy transfers with or without a feed pump, with or without a system mixer, with or without a heat exchanger and/or with or without a hydraulic switch

### BRIEF DESCRIPTION OF THE DRAWINGS

Further advantageous embodiments will be described in more detail below with reference to an embodiment shown in the drawings, to which the invention is not limited, however.

In the figures:

FIG. 1 shows a base configuration according to a first embodiment.

FIG. 2 is a hydraulic scheme of a multivalent energy supply system according to a second embodiment with two CHPs and two gas boilers.

FIG. 3 is a hydraulic scheme of a multivalent energy supply system according to a third embodiment with two wood boilers and a gas boiler.

FIG. 4 is a hydraulic scheme of a multivalent energy supply system according to a fourth embodiment with a heat pump and a gas boiler.

FIG. 5 is a hydraulic scheme of a multivalent energy supply system according to a fifth embodiment with two oil boilers and two gas boilers.

FIG. 6 is a hydraulic scheme of a multivalent energy supply system according to a sixth embodiment with two gas boilers, two CHPs and two wood boilers.

### DETAILED DESCRIPTION OF EMBODIMENTS

In the following description of a preferred embodiment of the present invention, like reference characters designate like or similar components.

### First Embodiment

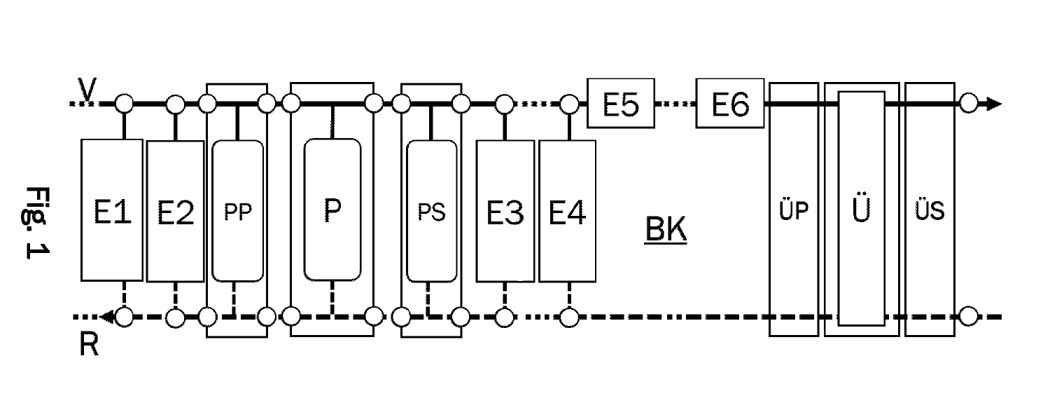

FIG. 1 shows a base configuration BK according to a first embodiment. The base configuration BK comprises six energy generators E1 . . . E6, three buffer storages P, PP, PS and three energy transfers U, ÜP, ÜS which are respectively arranged at a flow V and a return flow R. The energy generators E5, E6 which are connected in series, have no direct connection to the return flow. The number of energy generators may be expanded arbitrarily which is indicated by the dots in the representation of the flow and return flow lines.

In order to configure a specific infrastructure of a multivalent energy supply system, an apparatus according to the invention comprises a detection device. The apparatus may be, for example, a computer, tablet, smartphone or any other device with a graphical user interface. A base configuration BK is stored in a memory of the apparatus. The base configuration BK may be loaded from the memory. In a menu, a graphical representation of the base configuration BK may be displayed. By clicking or touching, an installer or other user may select specific implementations for each of the components from a list or a graphical representation of components in a menu.

By selecting the components, the user transfers the actual realized configuration of the energy supply system to a graphical representation of the system configuration AK. The generated system configuration AK may be a hydraulic scheme or block diagram of the energy supply system. Relationships of the components as well as information on their functions and effects are represented by the system configuration and can be detected therefrom by a control device. Furthermore, measuring points, sensors and other components included in the energy supply system may be added to the hydraulic scheme or block diagram (system configuration AK). For unoccupied positions in the base configuration BK, for example, direct connections may be placed in the respective location.

Step by step, the hydraulic scheme or block diagram AK of the energy supply system is thus generated. After all components have been selected, the completed configuration may be stored and transmitted to a control device.

The generated hydraulic scheme or block diagram may then be used by the control device to control the energy supply system.

### Second Embodiment

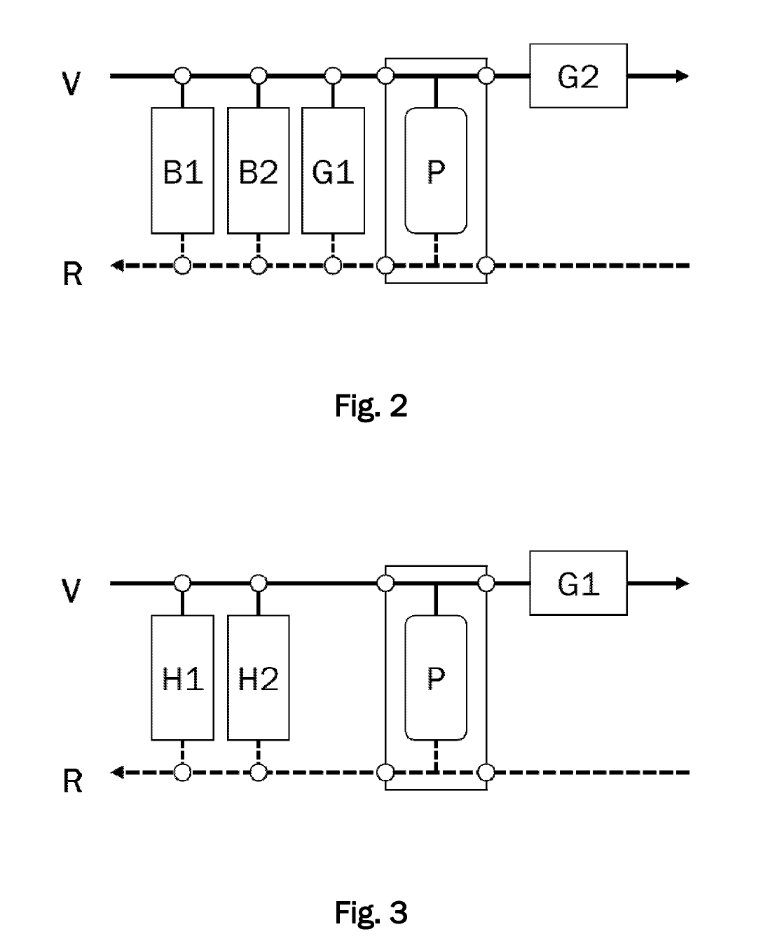

FIG. 2 shows a schematic illustration of an embodiment of a multivalent energy supply system for providing heat and electrical energy. FIG. 2 shows a hydraulic scheme of the energy supply system which was generated from a base configuration BK according to FIG. 1 by selecting the individual components.

The energy supply system comprises two combined heat and power plants (CHPs) B1, B2 and two gas boilers G1, G2, wherein the CHPs B1, B2 are each arranged in parallel to each other between a flow V and a return flow R. Via the return flow R, the carrier medium coming from the consumer side flows to the energy generators which supply heat to the carrier medium. Via the flow V, the carrier medium flows to the consumer circuit (not shown).

A first gas boiler G1 is also arranged in parallel to the CHPs B1, B2 downstream at the flow V. In addition, further downstream at the flow V, a buffer storage P is arranged in parallel to the first gas boiler G1 and the CHPs B1, B2. Downstream of the buffer storage P, a second gas boiler G2 is arranged in series in the flow V, so that the second gas boiler G2 can raise the flow temperature directly. Due to the arrangement of the second gas boiler G2 behind the buffer storage in the flow, it cannot influence the temperature of the water stored in the buffer storage.

Starting from the base configuration BK of FIG. 1, the hydraulic scheme of the second embodiment is configured by selecting three energy generators B1, B2, G1 in parallel to the buffer storage P in place of the first energy generator E1, E2. The primary-side PP and secondary-side PS buffer storages are each configured as a direct connection. The gas boiler G2 is selected as a serial energy generator at location E5 in FIGS. 1 and E6 is configured as a direct connection. The energy transfers are also configured as a direct connection.

### Third Embodiment

FIG. 3 shows a hydraulic scheme of an energy supply system according to a third embodiment. Similarly to the second embodiment, the energy supply system comprises a buffer storage P between flow V and return flow R and a gas boiler G1 in the flow V downstream of the buffer storage P. A first wood boiler H1 and a second wood boiler H2 are each arranged in parallel to each another and in parallel to the buffer storage P upstream at the flow V1.

Starting from the base configuration BK of FIG. 1, the hydraulic scheme of the third embodiment is configured by selecting the two wood boilers H1, H2 in parallel to the buffer storage P in place of the first energy generator E1, E2.

The primary-side PP and secondary-side PS buffer storages are each configured as a direct connection. The gas boiler G1 is selected as the first serial energy generator at location E5 in FIGS. 1 and E6 is configured as a direct connection. The energy transfers are also configured as a direct connection.

### Fourth Embodiment

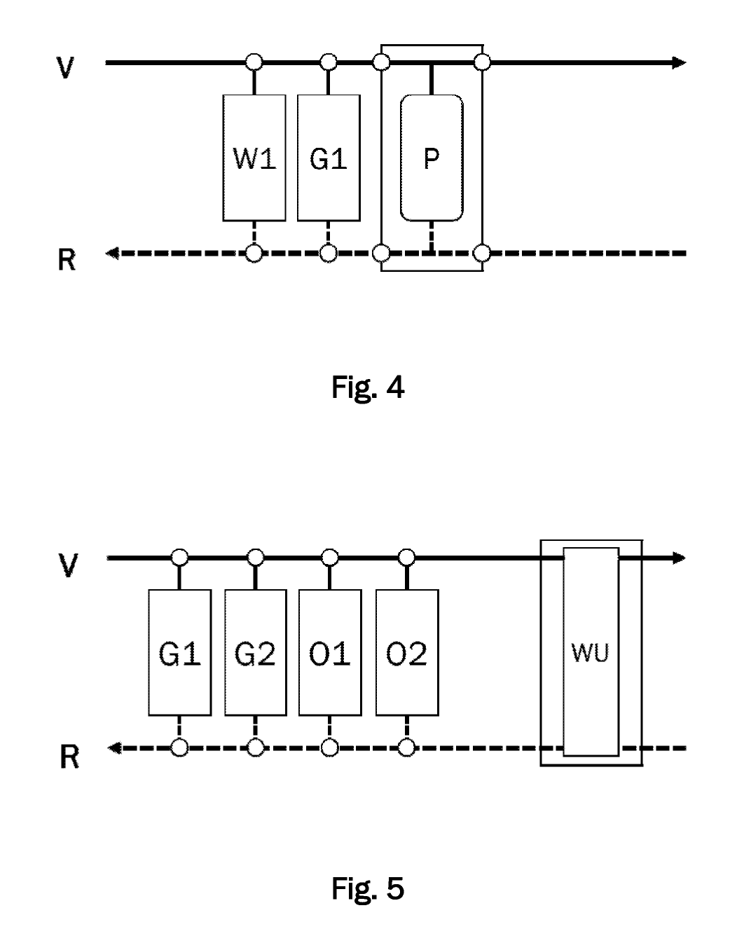

FIG. 4 shows a hydraulic scheme of an energy supply system according to a fourth exemplary embodiment. A heat pump W1 and a gas boiler G1 are arranged in parallel to each other and in parallel to a buffer storage P between flow V and return flow R.

Starting from the base configuration BK of FIG. 1, the hydraulic scheme of the fourth embodiment is configured by selecting the heat pump E1 and the gas boiler G1 in parallel to the buffer storage P instead of the first energy generators E1, E2. The primary-side PP and secondary-side PS buffer storages are each configured as a direct connection. The serial energy generators E5 and E6 are configured as a direct connection. The energy transfers are also configured as a direct connection.

### Fifth Embodiment

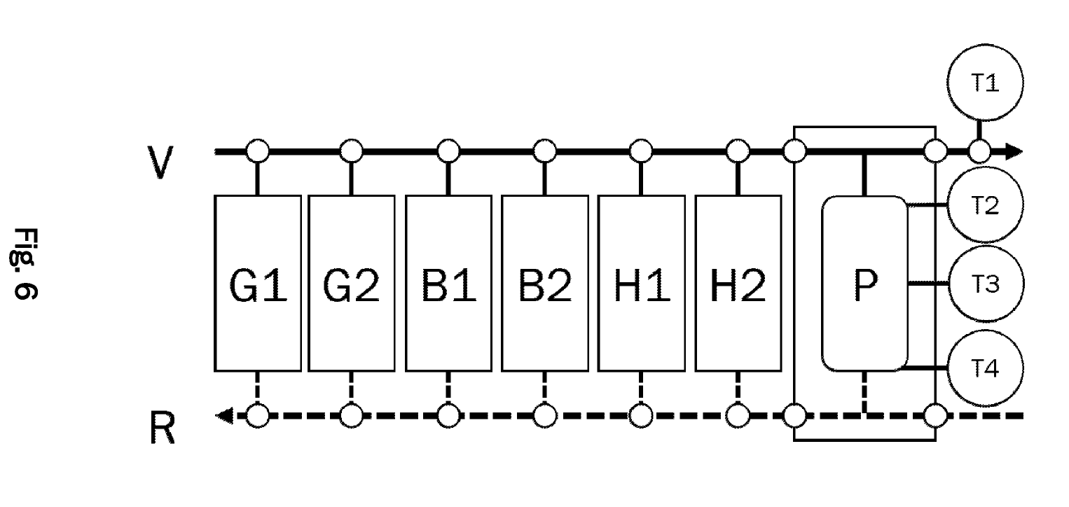

In a fifth embodiment, the energy supply system comprises two gas boilers G1, G2 and two oil boilers O1, O2 which are all arranged in parallel to each other between flow V and return flow R. For the transfer of heat to a consumer circuit, a heat transfer is provided. A hydraulic scheme of the energy supply system according to the fifth embodiment is shown in FIG. 5.

Starting from the base configuration BK of FIG. 1, the hydraulic scheme of the fifth embodiment is configured by selecting the two gas boilers G1, G2 in place of the first energy generators E1, E2. The two oil boilers O1, O2 are selected in place of the second energy generators E3, E4. The buffer storage P and the primary-side PP and secondary-side PS buffer storage are each configured as a direct connection. The serial energy generators E5 and E6 are configured as a direct connection. The energy transfer Ü is configured as heat transfer WÜ.

### Sixth Embodiment

FIG. 6 shows a hydraulic scheme of a multivalent energy supply system according to a sixth embodiment. The energy supply system comprises two gas boilers G1, G2, two CHPs B1, B2 and two wood boilers H1, H2, as well as a buffer storage P. In addition, a temperature sensor T1 measuring the energy supply system flow temperature is arranged in the flow V. In the buffer storage P, three temperature sensors T2, T3, T4 are arranged which measure the temperature in the buffer storage P in an upper portion, in a center portion and in a lower portion of the buffer storage, respectively.

Starting from the base configuration BK of FIG. 1, the hydraulic scheme of the sixth exemplary embodiment is configured by selecting the two gas boilers G1, G2, two CHPs B1, B2 and two wood boilers H1, H2 in place of the first energy generators E1, E2. The buffer storage P is configured as a buffer storage with four temperature sensors T1 to T4. The primary-side PP and secondary-side PS buffer storages are each configured as a direct connection. The serial energy generators E5 and E6 are also configured as direct connections.

The control of the energy supply system is performed depending on the detected configuration. All six energy generators can heat directly at the flow or the buffer. Since all energy generators are connected in parallel, they could work independently of each other.

A specification to a control device may be that a large amount of energy should be stored in the buffer storage P. From the hydraulic scheme, the control device recognizes that all energy generators can be used to store heat. Further, the control device recognizes that a buffer temperature sensor T4 at a lower portion of the buffer storage P can be selected for the buffer temperature control. For example, the buffer target temperature is set to 70° C. The control device S then ensures that the buffer storage P is completely charged to a temperature of 70° C.

If the buffer storage P is only to be charged approximately halfway, a buffer temperature sensor T3 in a center portion of the buffer storage P is selected for the buffer temperature control.

When no buffer storage is desired, a buffer temperature sensor T2 at an upper portion of the buffer storage P is selected for the buffer temperature control. It is not necessary to specify a buffer target temperature, since an energy generator flow target temperature can be calculated from a system flow target temperature. Only as much energy as is consumed by the consumers is generated, and the buffer P is not charged in this case. The system flow temperature can be measured, for example, by a temperature sensor T1 at the flow V.

The features disclosed in the foregoing description, the claims and the drawings may be of importance for the realization of the invention in its various forms both individually and in any combination.

### LIST OF REFERENCE SYMBOLS

BK base configuration
AK system configuration (hydraulic scheme)
V flow
R return flow
P buffer storage
PP primary-side buffer storage
PS secondary-side buffer storage
Ü energy transfer
ÜP primary-side energy transfer
ÜS secondary-side energy transfer
R1 first closed-loop controller
R2 second closed-loop controller
R3 third closed-loop controller
R4 fourth closed-loop controller
R5 fifth closed-loop controller
E1 first energy generator
E2 second energy generator
E3 third energy generator
E4 fourth energy generator
E5 fifth energy generator
E6 sixth energy generator
G1 first gas boiler
G2 second gas boiler
O1 first oil boiler
O2 second oil boiler
B1 first CHP
B2 second CHP
H1 first wood boiler
H2 second wood boiler
T1 first temperature sensor (flow)
T2 second temperature sensor (buffer storage top)
T3 third temperature sensor (buffer storage center)
T4 fourth temperature sensor (buffer storage bottom)

1. An apparatus for configuring a multivalent energy supply system, the apparatus comprising:
a memory device in which a base configuration (BK) is stored, the base configuration comprising:
a plurality of energy generators (E1-E6, B1, B2, G1, G2, H1, H2, O1, O2) which use at least two different energy carriers to provide energy in the form of heat and/or cold and/or electrical energy;
a flow (V) through which a carrier medium flows which receives energy from the energy generators (E1-E6, B1, B2, G1, G2, H1, H2, O1, O2) and transports it to a consumer circuit;
a return flow (R) which receives the carrier medium coming from the consumer circuit;
a buffer storage (P) arranged between the flow (V) and the return flow (R) for temporarily storing energy which is supplied to the buffer storage (P) via the flow (V);
wherein the energy generators (E1-E6, B1, B2, G1, G2, H1, H2, O1, O2) within the base configuration (BK) can be arranged at positions in parallel to the buffer storage (P) between the flow (V) and return flow (R) and/or in series in the flow (V); and
a detection device configured to detect, for each of the energy generators (E1-E6, B1, B2, G1, G2, H1, H2, O1, O2), a type from a predetermined set of energy generator types and a position of the energy generators (E1-E6, B1, B2, G1, G2, H1, H2, O1, O2) within the base configuration (BK) stored in the memory device; wherein
the apparatus is configured to transmit the base configuration (BK) to a control device which controls the energy generators (E1-E6, B1, B2, G1, G2, H1, H2, O1, O2) based on their detected type and position within the base configuration (BK).

2. The apparatus according to claim 1, wherein, in the base configuration (BK), at least two energy generators (E1-E6, B1, B2, G1, G2, H1, H2, O1, O2) are arranged in parallel to each other between the flow (V) and the return flow (R).

3. The apparatus according to claim 2, wherein, in the base configuration (BK), one of the at least two energy generators (E1-E6, B1, B2, G1, G2, H1, H2, O1, O2) is arranged upstream at the flow (V) with respect to the buffer storage (P).

4. The apparatus according to claim 3, wherein, in the base configuration (BK), the other of the at least two energy generators (E1-E6, B1, B2, G1, G2, H1, H2, O1, O2) is arranged downstream at the flow (V) with respect to the buffer storage (P).

5. The apparatus according to claim 1, wherein, in the base configuration (BK), a first energy transfer (Ü) at which the carrier medium flows into the consumer circuit via the flow (V) is arranged in parallel to the buffer storage (P).

6. The apparatus according to at bast claim 5, wherein, in the base configuration (BK) in parallel to the first energy transfer (Ü), at least one primary-side energy transfer (UP) is arranged upstream at the flow (V) and/or at least one secondary-side energy transfer (ÜS) is arranged downstream at the flow (V).

7. The apparatus according to claim 1, wherein, in the base configuration (BK) in parallel to the first buffer storage (P), at least one primary-side buffer storage (PP) is arranged upstream at the flow (V) and/or at least one secondary-side buffer storage (PS) is arranged downstream at the flow (V).

8. The apparatus according to claim 1, wherein at least one energy generator (E1-E6, B1, B2, G1, G2, H1, H2, O1, O2) is arranged in series between the buffer storage (P) and the energy transfer (Ü) in the flow (V).

9. The apparatus according to claim 1, wherein the detection device is further configured to detect, for each of the buffer storages (P, PP, PS), a type from a predetermined set of buffer storage types.

10. A method of configuring a multivalent energy supply system, the method comprising the steps of:
reading out a base configuration (BK) from a memory device, wherein the base configuration (BK) comprises at least:
a plurality of energy generators (E1-E6, B1, B2, G1, G2, H1, H2, O1, O2) which use at least two different energy carriers to provide energy in the form of heat and/or cold and/or electrical energy;
a flow (V) through which a carrier medium flows which receives energy from the energy generators (E1-E6, B1, B2, G1, G2, H1, H2, O1, O2) and transports it to a consumer circuit;
a return flow (R) which receives the carrier medium coming from the consumer circuit;
a buffer storage (P) arranged between the flow (V) and the return flow (R) for temporarily storing energy which is supplied to the buffer storage (P) via the flow (V);
a first energy transfer (Ü) arranged in parallel to the buffer storage (P) and at which the carrier medium flows into the consumer circuit via the flow (V);
wherein the energy generators (E1-E6, B1, B2, G1, G2, H1, H2, O1, O2) within the base configuration (BK) can be arranged at positions in parallel to the buffer storage (P) between the flow (V) and return flow (R) and/or in series in the flow (V); and
detecting, by a detection device, for each of the energy generators (E1-E6, B1, B2, G1, G2, H1, H2, O1, O2) a type from a predetermined set of energy generator types and a position of the energy generator (E1-E6, B1, B2, G1, G2, H1, H2, O1, O2) within the base configuration (BK) stored in the memory device;
generating a system configuration (AK) from the base configuration and the detected types and positions of energy generators (E1-E6, B1, B2, G1, G2, H1, H2, O1, O2); and
transmitting the generated system configuration (AK) to a control device which controls the energy generators (E1-E6, B1, B2, G1, G2, H1, H2, O1, O2) based on the transmitted system configuration (AK).
